(19) United States
(12) Patent Application Publication
(10) Pub. No.: US 2011/0197826 A1
(43) Pub. Date: Aug. 18, 2011

(54) Collar light band for pets

(76) Inventor: Marni Markell Hurwitz, Far Hills, NJ (US)

(21) Appl. No.: 12/658,690

(22) Filed: Feb. 13, 2010

(51) Int. Cl. A01K 27/00; B32B 37/00

(52) U.S. Cl. 119/859; 119/863; 29/592.1

(57) ABSTRACT

A collar light band is worn by a pet as an accessory that imparts safety to the pet. The collar light band is constructed as a hollow band having a proximal end, distal end and central portion. At least one light emitting means is integrated within the proximal end of the hollow band. The light emitting means is in communication with a power source, preferably a battery. At least one light emitting segment is integrated within the hollow band. In operation, the collar light band is appointed to be placed on the pet and worn as an accessory or as a safety device and is not appointed to be utilized as a collar-leash assembly for restraining the pet. The band may be constructed to be worn around the pet's neck, or may be constructed to be worn around an ankle of a pet. Advantageously, the collar light band imparts safety to the pet by increasing visibility at night, dusk or inclement weather conditions.

### BACKGROUND OF THE INVENTION

1. Field of the Invention

The present invention relates to a collar light band appointed to be worn by a pet; and more particularly, to a tubular collar band having a proximal end, distal end and central portion, wherein at least one light emitting means is integrated within the proximal end of the tubular collar and there is at least one light emitting segment integrated within the collar. The collar light band is appointed to be placed over an animal's head for walking in dimly lit areas, during inclement weather, or in dusk or nighttime hours for safety and is not appointed to be used to restrain the pet during walking/or to be used as a pet collar.

2. Description of the Prior Art

Walking a pet during dusk or nighttime hours can be hazardous in neighborhoods where automobiles are encountered. Illuminating characteristics of the automobile headlamps, generally afford an illumination range of approximately 25 to 50 feet. This illumination range can be significantly reduced by mist or fog, or bends in the road. Despite improvements to vehicle headlights, pets and their owners are oftentimes not recognized by automobile drivers until the distance between the automobile and the pet is small.

Illuminated pet collars have been devised by prior art workers attempting to provide solutions for this hazardous common activity. None of these solutions suggest a collar light band that is appointed to be placed over an animal's head to be worn in conjunction with the actual restraining collar. The collars heretofore disclosed are to be worn as restraining collars for walking the pet, and are not merely worn as a band to provide illumination. Examples of illuminated pet collars include: U.S. Pat. Nos. 4,173,201; 4,895,110; 5,046,456; 5,140,946; 5,370,082; 5,523,927; 5,535,106; and 6,557,498.

Various illuminated leashes/harnesses have also been heretofore disclose and utilized. However, the leashes/harnesses are provided for restraining or walking the pet, and do not provide a simple band that can be slipped over the pet's neck. Examples of illuminated leashes include: U.S. Pat. Nos. 4,513,692; 4,887,552; 5,429,075; 5,558,044; 5,630,382; 5,850,807; and 5,967,095. Other leashes have provided a flashlight that is combined with the leash. For example, see U.S. Pat. Nos. 5,762,029; and 6,289,849.

Notwithstanding the efforts of prior art workers to provide illumination for pet safety, there remains a need in the art for a collar light band appointed to be worn by a pet, which is not a restraining type collar, but is merely a band placed on the pet's neck for safety when the pet is being walked in dimly lit or dark conditions. Also needed is a hollow band wherein at least one light emitting means is integrated therein so that light is emitted from the band. Further, there is a need in the art for a collar light band that is appointed to be placed over an animal's head for walking in dimly lit areas, during inclement weather, or in dusk or nighttime hours for safety and is not appointed to be used to restrain the pet during walking/or to be used as a pet collar.

### SUMMARY OF THE INVENTION

The present invention provides a collar light band appointed to be worn by a pet for providing visibility and safety. The collar light band is not to be used as a restraining type collar, but is merely constructed as band placed on the pet's neck when dark for safety in conjunction with the pet's normal collar-leash assembly. The collar light band is constructed as a hollow band wherein at least one light emitting means is integrated so that light is emitted from the band. The collar light band is appointed to be placed over an animal's head for walking in dimly lit areas, during inclement weather, or in dusk or nighttime hours for safety and is not appointed to be used to restrain the pet during walking/or to be used as a pet collar.

The collar light band appointed to be worn by a pet is constructed having a hollow band with a proximal end, distal end and central portion. At least one light emitting means is integrated within the proximal end of the hollow band. The light emitting means is in communication with a power source. The power source is preferably a battery in further communication with an on/off activation switch, which may be in further communication with a light sensor. At least one light emitting segment is integrated within the hollow band. The collar light band is appointed to be placed on the pet and worn as an accessory or as a safety device. It may be formed as a larger ring to be placed upon the pet's neck, or it may be formed as a small ring to be placed on the pet's ankle. The tube may be formed as a closed ring; or may be formed so that the proximal and distal ends can be detached from one another when not in use. The tube is preferably flexible, and may be put in place by snapping, magnetic closure or a metal/plastic clasp.

A method of using a collar light band appointed to be worn by a pet is also provided. The method of using comprises a first step of placing a hollow band having a proximal end, distal end and central portion formed as a ring onto a neck of a pet. At least one light emitting segment is integrated within the hollow band. The next step involves activating at least one light emitting means that is integrated within the proximal end of the hollow band, the light emitting means being in communication with a power source. The last step involves wearing the hollow band on the pet as an accessory to impart safety to the pet. Advantageously, the collar light band imparts safety to the pet by imparting visibility at night, dusk or inclement weather conditions.

Additionally, a method of manufacturing a collar light band appointed to be worn by a pet is provided. The method of manufacture comprises steps of: (i) forming a hollow band having a proximal end, distal end and central portion; (ii) integrating at least one light emitting means within the proximal end of the hollow band, the light emitting means being in communication with a power source; and (iii) forming at least one light emitting segment within the hollow band, wherein the collar light band is appointed to be placed on the pet and worn as an accessory which additionally functions as a safety device.

### BRIEF DESCRIPTION OF THE DRAWINGS

The invention will be more fully understood and further advantages will become apparent when reference is had to the following detailed description of the preferred embodiments of the invention and the accompanying drawings, in which:

FIG. 1 illustrates a schematic view of the collar light band being worn by dog for providing visibility and safety;

FIG. 2a shows a schematic view of the collar light band in the open configuration;

FIG. 2b shows a sectional view of the proximal and distal ends of the collar light band in the open configuration;

FIG. 2c shows a schematic view of the collar light band in the closed configuration with the light activated;

FIG. 3a shows a sectional view of the proximal and distal ends of the collar, showing an embodiment of the light emitting means wherein closure means is by way of screw closure;

FIG. 3b shows a sectional view of the proximal and distal ends of the collar, showing an embodiment of the light emitting means wherein closure means is by way of snap-fit closure; and

### DETAILED DESCRIPTION OF THE INVENTION

A collar light band appointed to be worn as an accessory that imparts safety to a pet, method of use and manufacturing same, is provided. The collar light band is constructed as a hollow band having a proximal end, distal end and central portion, preferably forming a hollow tube. At least one light emitting means is integrated within the proximal end of the hollow band. The light emitting means is in communication with a power source, preferably a battery. At least one light emitting segment is integrated within the hollow band. In operation, the collar light band is appointed to be placed on the pet and worn as an accessory or as a safety device and is not appointed to be utilized as a collar-leash assembly for restraining the pet. The band may be constructed to comfortably conform to the neck of the pet, enabling it to be conveniently slipped over and worn around the pet's neck; or the band may be constructed to conform to the size of a pet's ankle, enabling it to be placed on the pet's ankle by snapping, magnetic closure or metal/plastic clasp, hook and loop fasteners of the type sold under the name Velcro® and thereby worn around an ankle of a pet. Advantageously, the collar light band imparts safety to the pet by increasing visibility at night, dusk or inclement weather conditions.

The collar light band is constructed of a lightweight durable material and provides a device that can readily be donned onto a pet's neck or ankle to impart safety to the pet. The collar light band is water resistant and very easy to handle. It's simply just slipped onto the animal when taking the pet for a walk in inclement weather, dusk or nighttime hours so that vehicles and others can readily see the pet. The collar light is preferably made from plastic, foam, vulcanized foam material. It may be constructed of a foam material and include a transparent segment with a face plate having a plurality of cut-outs for emanating light. Alternatively, it may be constructed with perforated apertures that allow for emission of light. The cut-outs or apertures can have a plethora of shapes, such as stars, diamonds, circles, triangles, characters, or indicia for advertising, the pet's name, and the like.

The collar light can be formed as a continuous ring—or, more preferably can be formed as a ring that can be opened and closed wherein the two ends (distal and proximal) snap together to close the ring when it is being worn. Closure can be achieved in a variety of ways, including snap closure, magnetic closure, screw closure, hook and loop, etc.

Lighting means utilized by the collar light band is preferably LED lighting; alternatively fiber optic lighting may be used. Both LED and fiber optic lighting provide long lasting light sources that can run on minimal power and do not emit heat. As a result, the collar is very safe for the pet to wear. The lights can comprise an array of colors and designs. There may be a single light, or multiple lights may be provided. Using LED or fiber optics allows a long light life, lasting more than 2000 hours. Preferably, the tube or collar light band is transparent so that light is emitted therefrom. The collar light can be made in a variety of different weights, sizes, colors and thicknesses. Despite the collar light band's durability, the band is not appointed to be used as a collar for a leash as it is not constructed for restraining the pet. The object of the collar light band is to impart visibility to the pet and it is especially well suited for use when the pet will be in low visibility conditions. At such time, it is to be placed onto the pet separate and distinct from the collar-leash assembly, and worn by the pet.

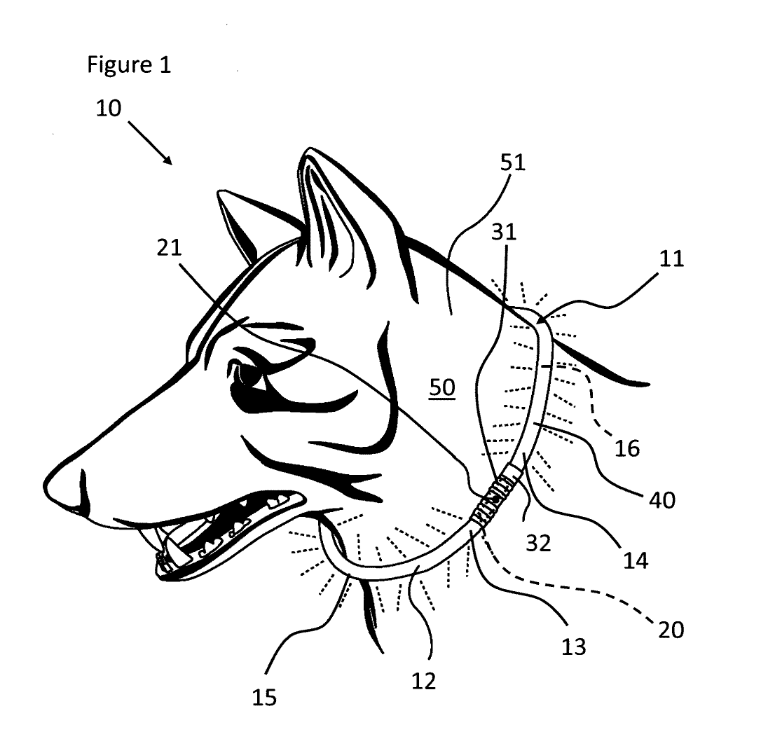

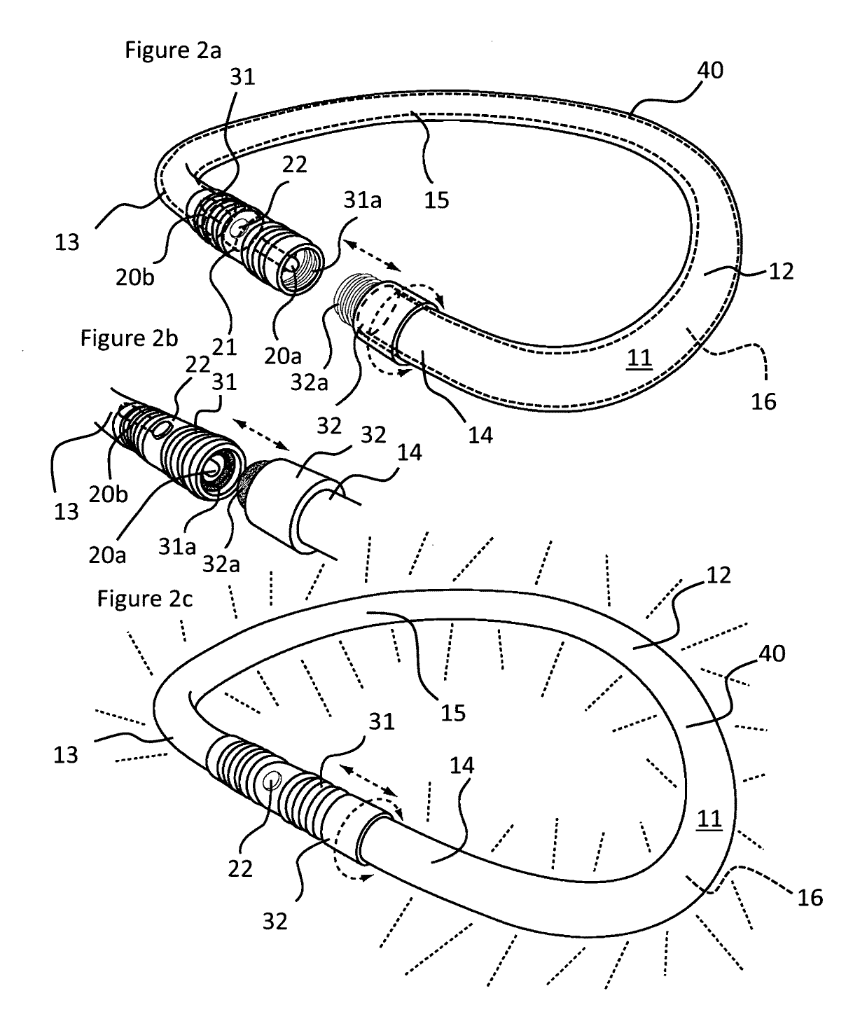

FIG. 1 illustrates a schematic view of an adjustable collar light band being worn by dog for providing visibility and safety, shown generally at 10. FIGS. 2a-2c illustrate views of the collar light band, showing the band in the open configuration in FIG. 2a, and showing cross-sectional views of the proximal and distal ends in the open and closed configurations in FIGS. 2b and 2c, respectively. Referring to FIG. 1 and FIGS. 2a-2b, a collar light band 11 is appointed to be worn by a pet/dog 50, preferably around its neck 51, but alternatively the collar band 10 may be constructed as a smaller ring to be worn on the dog's 50 ankle (ankle not shown). The collar light band 11 comprises a hollow band 12 having a proximal end 13, distal end 14 and central portion 15, preferably constructed to form a hollow circular/semi-circular tube 16 (or a hollow half-moon or semi-flat strip). At least one light emitting means 20 is integrated within the proximal end 13 of the hollow band 12 (herein two LEDs 20 are provided). The light emitting means 20 is in communication with a power source 21 in communication with an on/off switch 22.

Additionally, at least one light emitting segment 40 is integrated within the hollow band 12 for emanating light from the band 12. In the embodiment shown, the light emitting segment 40 substantially comprises the central portion 15 of the hollow band 12. Although the band 12 shown in the drawings is substantially hollow, the band 12 need only be partially hollow. Preferably the light emitting segment 40 is located within the central portion 15, and, as shown, it preferably substantially comprises the central portion 15 so that virtually the entire band 12 emits 360 degrees of light. The light emitting segment 40, and in this case substantially the entire band 12, is composed of at least one transparent portion appointed for emanating light. The transparent segment 40 may include a covering or face plate having cut-outs for emanating light.

The light emitting segment 40 is preferably 360 degrees, providing omnidirectional light emanating from the hollow band 12. As a result, optimal visibility is provided so that vehicles and others can readily see the pet and the pet owner. Without 360 degrees of light emission all around the band 12, the path of the light will be interfered with by objects, including the pet's own fur, the separate collar-leash assembly worn by the pet, or the pet's head. 360 degree omnidirectional emission of light optimally mitigates such interference and always imparts high visibility. In the embodiment shown, a second LED is provided on the proximal end (20a, 20b) that is oppositely placed to one another so that the first LED 20a shines toward the second 20b, and the second 20b to the first 20a, further optimizing light emission from the band 12. The light emitting means 20, 20a, 20b may comprise fiber optic lighting rather than/or in combination with LED.

The proximal and distal ends, 13, 14, preferably include mating closure means 31, 32, respectively, so that the hollow band 12 can be opened and closed. Closure means 31, 32 may be screw closures 31a, 32a or snap closures, or may be hook and loop type fasteners (such as are sold under the trade name VELCRO®), or magnetic closures. The closure means may be constructed so that when closure means 31 and 32 meet or are connected, the electric circuit powering the light means 20 is closed and thereby secured in place, to thereby emit light from the segment 40. Conversely, when the closures means 31 and 32 are disconnected, the circuit is open and light means 20 is not activated to emit light. This is advantageous, in that the light need not be on at all times. For example, where the closure means 31, 32 are magnetic, the circuit may be closed when the closure means 31, 32 are connected so that light is emitted from the band 12.

Band 12 may be composed of a plethora of materials. In one embodiment the band 12 is composed of a polymeric material. Alternatively, the band 12 may be composed of a material selected from a group consisting of rubber and silicone. In another embodiment, the band 12 is composed of a foam material. The band 12 is only for use in emanating light or for decoration, and although durable, it is not constructed for use to act as a collar-leash assembly used to restrain the pet during walking.

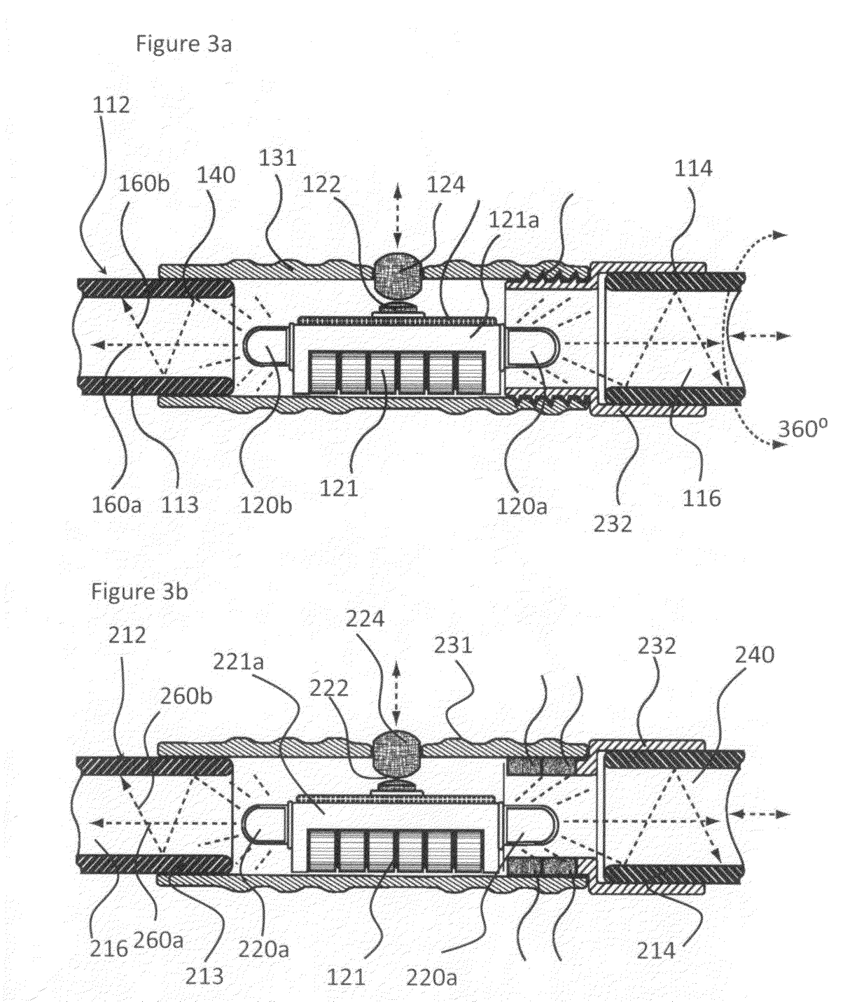

FIGS. 3a and 3b show sectional views of the proximal and distal ends of the collar, showing an embodiment of the light emitting means wherein closure means is by way of screw closure (FIG. 3a, shown at 100) and snap-fit closure (FIG. 3b, shown at 200). The collar light band comprises a hollow band 112, 212 having a proximal end 113,213 distal end 114, 214 and central portion (not shown), preferably constructed to form a hollow circular/semi-circular tube 116, 216 (or a hollow semi-flat strip). The proximal and distal ends preferably include mating closure means 131, 132, (231, 232) respectively, so that the hollow band 112, 212 can be opened and closed. Closure means 131, 132, (231, 232) may be screw closures (FIG. 3a) or snap closures (FIG. 3b), or may be hook and loop type fasteners (such as are sold under the trade name VELCRO®), or magnetic closures.

At least one light emitting means 120, 220 is integrated within the proximal end 113, 213 of the hollow band 112, 212 (herein one or two LEDs/optics 120a, 120b (220a, 220b) are provided). The light emitting means 120a, 120b are in communication with a power source 121, 221 (battery) housed in a chamber 121a, 221a in communication with an on/off switch 122, 222 in communication with a knob 124, 224. Rather than a switch 122, on/off can be achieved by providing an internal ring (not shown) which, when closures engage, the switch is closed, and thereby activated into the on condition; and conversely, when closures are not connected or the band is open, the switch is activated into the off condition. Additionally, at least one light emitting segment 140, 240 is integrated within the hollow band 112, 212 for emanating light. Due to the 360 degree nature of the segment 140, 240, light is emitted from a plethora of angles 160a, 160b (260a, 260b)—forming 360 degrees of light emission.

Having thus described the invention in rather full detail, it will be understood that such detail need not be strictly adhered to, but that additional changes and modifications may suggest themselves to one skilled in the art. For example, matching bands can be worn by both the pet and the pet owner. Such changes are intended to fall within the scope of the invention as defined by the subjoined claims.

What is claimed is:

1. A collar light band appointed to be worn by a pet, comprising:
a. a hollow band having a proximal end, distal end and central portion;
b. at least one light emitting means integrated within said proximal end of said hollow band, said light emitting means being in communication with a power source; and
c. at least one light emitting segment integrated within said hollow band, wherein said collar light band is appointed to be placed on said pet and worn as an accessory or as a safety device.

2. A collar light band as recited by claim 1, wherein said light emitting segment is located within said central portion.

3. A collar light band as recited by claim 2, wherein said light emitting segment substantially comprises said central portion.

4. A collar light band as recited by claim 2, wherein said light emitting segment comprises a plurality of segments located within said central portion.

5. A collar light band as recited by claim 1, wherein said light emitting segment comprises at least one transparent portion appointed for emanating light.

6. A collar light band as recited by claim 5, wherein said transparent portion includes a face plate having cut-outs and said cut-outs are appointed for emanating light.

7. A collar light band as recited by claim 1, wherein said light emitting segment comprises at least one transparent portion substantially comprising said central portion and wherein said transparent portion includes a face plate having cut-outs and said cut-outs are appointed for emanating light.

8. A collar light band as recited by claim 1, wherein said light emitting segment is 360 degrees, providing omnidirectional light emanating from said hollow band.

9. A collar light band as recited by claim 1, wherein a second light emitting means is integrated within said proximal end of said hollow band.

10. A collar light band as recited by claim 1, wherein said light emitting means comprises at least one light emitting diode.

11. A collar light band as recited by claim 1, wherein said light emitting means comprises fiber optic lighting.

12. A collar light band as recited by claim 1, wherein said proximal and distal ends include connecting closure means so that said hollow band can be opened and closed.

13. A collar light band as recited by claim 12, wherein said connecting closure means of said proximal and distal ends comprise connecting magnetic closures.

14. A collar light band as recited by claim 13, wherein said connecting magnetic closures close a circuit of said power source so that said power source is activated and said light emitting means is emits light when said proximal and distal ends meet.

15. A collar light band as recited by claim 12, wherein said connecting attachment means of said proximal and distal ends comprise connecting hook and loop fasteners.

16. A collar light band as recited by claim 12, wherein said connecting attachment means of said proximal and distal ends comprise connecting snap closure mechanisms.

17. A collar light band as recited by claim 12, wherein said connecting attachment means of said proximal and distal ends comprise connecting screw closure mechanisms.

18. A collar light band as recited by claim 1, wherein said hollow band is composed of a polymeric material.

19. A collar light band as recited by claim 1, wherein said hollow band is composed of a material selected from a group consisting of rubber and silicone.

20. A collar light band as recited by claim 1, wherein said hollow band is composed of a foam material.

21. A collar light band as recited by claim 1, wherein said hollow band is constructed only for use in emanating light and is not constructed for use to act as a collar-leash assembly used to restrain said pet during walking.

22. A collar light band as recited by claim 1, wherein said hollow band is formed and sized as a ring to be placed around a neck of said pet as a neck band.

23. A collar light band as recited by claim 1, wherein said hollow band is formed and sized as a ring to be placed around an ankle of a pet as an ankle band.

24. A collar light band as recited by claim 1, wherein said hollow band has a half-moon shape.

25. A collar light band as recited by claim 1, wherein said hollow band has a flat shape.

26. A collar light band as recited by claim 1, wherein said hollow band has a plurality of apertures configured to identify the name of the pet.

27. A collar light band as recited by claim 1, as recited by claim 1 wherein said hollow band has a pocket for housing keys and pet identifying information.

28. A collar light band as recited by claim 1, wherein said hollow band is used as a carrier for containers housing waste bags.

29. A collar light band as recited by claim 1, wherein said light emitting means comprise a plurality of LED's/optics having varying colors.

30. A collar light band as recited by claim 1, wherein said collar light band is light weight, durable and water resistant.

31. A method of using a collar light band appointed to be worn by a pet, comprising steps of:
a. placing a hollow band having a proximal end, distal end and central portion, and wherein at least one light emitting segment is integrated within said hollow band;
b. activating at least one light emitting means that is integrated within said proximal end of said hollow band, said light emitting means being in communication with a power source; and
c. wearing said hollow band on said pet as an accessory to impart safety to said pet.

32. A method of manufacturing a collar light band appointed to be worn by a pet, comprising steps of:
a. forming a hollow band having a proximal end, distal end and central portion;
b. integrating at least one light emitting means within said proximal end of said hollow band, said light emitting means being in communication with a power source; and
c. forming at least one light emitting segment within said hollow band, wherein said collar light band is appointed to be placed on said pet and worn as an accessory or as a safety device.
